(19) United States
(12) Patent Application Publication
(10) Pub. No.: US 2020/0361334 A1
(43) Pub. Date: Nov. 19, 2020

(54) CHARGING RATE FORECASTING SYSTEM FOR ELECTRIC VEHICLE AND METHOD THEREFOR

(71) Applicants: Hyundai Motor Company, Seoul (KR); Kia Motors Corporation, Seoul (KR)

(72) Inventors: Deok-Hwan Seo, Incheon (KR); Jong-Chan Jun, Hwaseong-si (KR); Kwon-Hyoung Choi, Suwon-si (KR); Jin-Hyung Lee, Seoul (KR)

(21) Appl. No.: 16/691,375

(22) Filed: Nov. 21, 2019

(30) Foreign Application Priority Data
May 15, 2019 (KR) 10-2019-0057210

(51) Int. Cl. B60L 53/64; B60L 53/62

(52) U.S. Cl. CPC B60L 53/64; B60L 53/62

(57) ABSTRACT

A system for forecasting a charging rate at the time of charging an electric vehicle includes: a server receiving and storing information on a charging rate from an electric power supplier; and a processor configured to: receive the information on the charging rate from the server and receive voltage information and current information charged in a vehicle from a charger installed to charge the electric vehicle; to calculate the charging rate of the vehicle according to the information on the charging rate and the voltage information and the current information input from the charger; and to transfer the calculated charging rate to an electronic control unit of the vehicle.

### CROSS-REFERENCE TO RELATED APPLICATIONS

The present application claims the benefit of priority to Korean Patent Application No. 10-2019-0057210, filed on May 15, 2019 in the Korean Intellectual Property Office, the entire disclosure of which is incorporated herein by reference.

### TECHNICAL FIELD

The present disclosure relates to a system for forecasting a charging rate at the time of charging an electric vehicle and a method therefor, and more particularly, to a charging rate forecasting system for an electric vehicle which includes: a server receiving and storing information on a charging rate from an electric power supplier; an input module receiving the information on the charging rate from the server and receiving voltage information and current information charged in a vehicle from a charger installed to charge the electric vehicle; a rate calculating module calculating the charging rate of the vehicle according to the information on the charging rate input into the input module and the voltage information and the current information input from the charger; and an output module transferring the charging rate calculated by the charge calculating module to an electronic control unit of the vehicle.

### BACKGROUND

In recent years, as the spread of electric vehicles have become activated, electric vehicles have been increasingly charged and used in private homes or apartment buildings.

In this case, it is easy to check a rate after an electric rate is charged because it is easy to check an electric power consumption of the private home.

On the contrary, in the case of the apartment buildings, since multiple users commonly use a charger, there is a problem in that it is difficult to check an electric power amount used for charging vehicles of the multiple users, and as a result, it is necessary to check whether the corresponding electric charge is accurate at the time of imposing apartment building maintenance cost.

The information included in this Background section is only for enhancement of understanding of the general background of the present disclosure and may not be taken as an acknowledgement or any form of suggestion that this information forms the prior art already known to a person skilled in the art.

### SUMMARY

The present disclosure has been made in an effort to provide a charging rate forecasting system for an electric vehicle and a method therefor which allow a user of the electric vehicle to check whether maintenance cost is wrongly imposed by checking a charging rate of the electric vehicle, thereby preventing a dispute due to the maintenance cost.

The present disclosure has been made in an effort to economically operate and maintain a vehicle by assisting forecasting the charging rate of the electric vehicle.

According to an exemplary embodiment of the present disclosure, a charging rate forecasting system for an electric vehicle may include: a server receiving and storing information on a charging rate from an electric power supplier; an input module receiving the information on the charging rate from the server and receiving voltage information and current information charged in a vehicle from a charger installed to charge the electric vehicle; a rate calculating module calculating the charging rate of the vehicle according to the information on the charging rate input into the input module and the voltage information and the current information input from the charger; and an output module transferring the charging rate calculated by the charge calculating module to an electronic control unit of the vehicle.

According to an exemplary embodiment of the present disclosure, a charging rate forecasting system for an electric vehicle and a method therefore can forecast an electric rate to be imposed through a bill by calculating an electric power amount used in an apartment building and a rate system of a used charger.

Accordingly, a dispute for maintenance cost can be prevented by checking whether maintenance cost including an electric charge is appropriately imposed and a user forecasts the electric rate, thereby economically operating and maintaining a vehicle.

### BRIEF DESCRIPTION OF THE DRAWINGS

FIG. 1 is a block diagram of a charging rate forecasting system for an electric vehicle according to an exemplary embodiment of the present disclosure;

FIG. 2 is a diagram illustrating an example of charging rate information stored in a server according to an exemplary embodiment of the present disclosure;

FIG. 3 is a diagram illustrating an example of charging rate data calculated by a rate calculating module according to an exemplary embodiment of the present disclosure; and

FIG. 4 is a flowchart of a charging rate forecasting method for an electric vehicle according to an exemplary embodiment of the present disclosure.

### DETAILED DESCRIPTION

Hereinafter, configurations of a charging rate forecasting system for an electric vehicle according to the present disclosure and a method therefor will be described with reference to drawings.

However, disclosed drawings are provided as an example for allowing those skilled in the art to sufficiently appreciate the spirit of the present disclosure. Accordingly, the present disclosure is not limited to drawings presented below, but may be embodied in other aspects.

Unless otherwise defined, the terms used in the description of the present disclosure have the same meaning as commonly understood by those skilled in the art to which the present disclosure belongs and in the following description and the accompanying drawings, a detailed description of known functions and configurations that may unnecessarily blur the gist of the present disclosure is omitted.

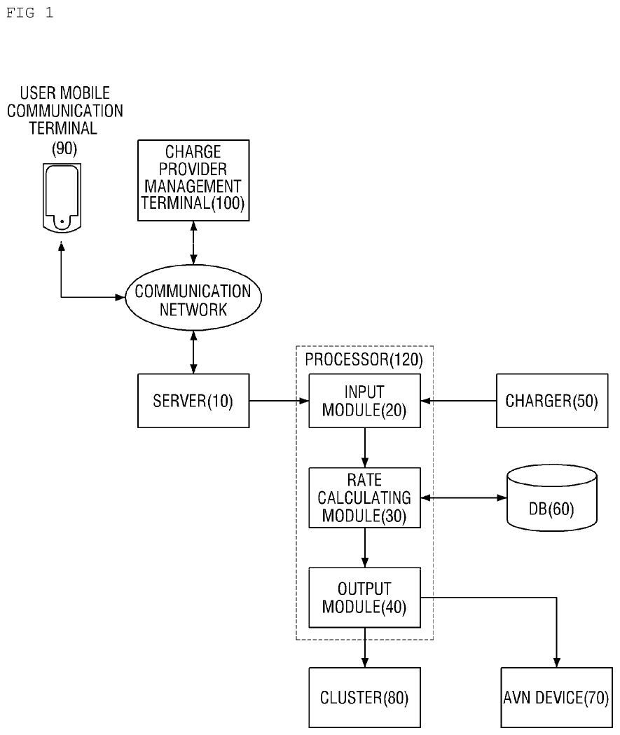

FIG. 1 is a block diagram of a charging rate forecast system for an electric vehicle according to an exemplary embodiment of the present disclosure.

Referring to FIG. 1, the charging rate forecast system for an electric vehicle according to an exemplary embodiment of the present disclosure may include a server 10 receiving and storing information on a charging rate from an electric power supplier. The charging rate forecast system according to an exemplary embodiment of the present disclosure may further include a processor 120 (e.g., computer, microprocessor, CPU, ASIC, circuitry, logic circuits, etc.). The processor 120 may have an associated non-transitory memory storing, e.g., a program(s), software instructions, which, when executed by the processor 120, provide the functionalities of: an input module 20 receiving the information on the charging rate from the server 10 and receiving voltage information and current information charged in a vehicle from a charger 50 installed to charge the electric vehicle; a rate calculating module 30 calculating the charging rate of the vehicle according to the information on the charging rate input into the input module 20 and the voltage information and the current information input from the charger 50; and an output module 40 transferring the charging rate calculated by the charge calculating module 30 to an electronic control unit of the vehicle. The processor 120 may take the form of one or more processor(s).

The input module 20 according to an exemplary embodiment of the present disclosure may be a communication device which is a hardware device implemented by various electronic circuits (e.g., processor) to transmit and receive signals via wireless or wired connections.

Hereinafter, the charging rate forecast system for an electric vehicle according to an exemplary embodiment of the present disclosure configured as above will be described in detail.

The server 100 stores information (hereinafter, referred to as charging rate information) on the charging rate of electricity charged in the vehicle and specifically, the charging rate information may be information on a charge provider that supplies electricity, charge information for each charge time, or charging rate information per month.

The charging rate information is transferred from a management terminal 100 of a charge provider that supplies the electricity and transferred to the server 10 through a communication network.

When the charging rate information is changed or a new provider is added, the charged charging rate information is periodically updated to the server 10.

Preferably, when a user selects the charge provider that supplies the electricity through an Audio-Video-Navigation (AVN) device of the vehicle before starting charging the corresponding vehicle, the input module 20 may load the charge provider information, the charging information per charging time period, and the charging information per month stored in the server 10.

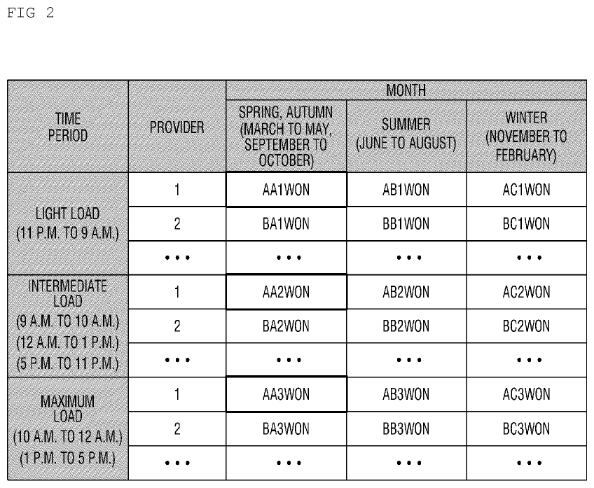

FIG. 2 illustrates an example of the charging rate information stored in the server 10 according to an exemplary embodiment of the present disclosure and charging rate information of spring (e.g., March to May), autumn (e.g., September to October), summer (e.g., June to August), and winter (e.g., November to February) is disclosed per charge provider and per month by partitioning intervals of a light load (e.g., 11 p.m. to 9 a.m.), an intermediate load (e.g., 9 a.m. to 10 a.m., 12 a.m. to 1 p.m., 5 p.m. to 11 p.m.), and a maximum load (e.g., 10:00 a.m. to 12 a.m., 1 pm to 5 p.m.) per charging time period.

The input module 20 receives the charging rate information and receives the voltage information and the current information charged in the vehicle from the charger 50. In this case, the input module 20 receives voltage information and current information of electricity charged into the vehicle from an Electronic Control Unit (ECU) of the vehicle through the charger 50 by using a Controller Area Network (CAN) communication line of the vehicle.

The rate calculating module 30 of the processor 120 calculates the charging rate of the corresponding vehicle by using the charging rate information input into the input module 20 and the voltage information and the current information charged in the vehicle.

To this end, the rate calculating module 30 stores a charged electric power amount per time period by accumulating the voltage information and the current information and calculates the charging rate per month according to the charging rate information of the charge provider input from the server 10 by using the stored charged electric power amount. In addition, the calculated charging rate is stored and managed in a linked database (DB) 60.

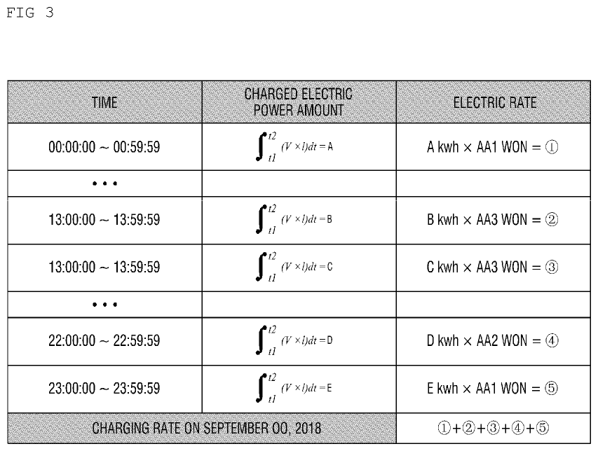

FIG. 3 illustrates an example of charging rate data calculated by the rate calculating module 30 and a charged electric power amount is accumulated in each record for each data according to a time period for each charging date, the charging rate is calculated and displayed according to the accumulated charged electric power amount, and the charging rate for each day is calculated by adding up all charging rates.

Here, the charged electric power amount is calculated according to Equation 1 to calculate electric power below.

P (charged electric power amount) (W)=V (charged voltage) (V)×I (charged current amount) (I) (Equation 1)

Further, the charging rate is calculated according to Equation 2 below.

C (charging rate)=P (charged electric power amount) (W)×K (charging rate information in corresponding charging time period) (Equation 2)

Preferably, at the time of calculating the charged electric amount, a CAN communication signal of battery voltage is used for the voltage, and current input into an On-Board Charger (OBC) is used at the time of slow charging and a CAN communication signal of current input into a battery is used at the time of boosting charging for the current.

The rate calculating module 30 calculates a daily rate for the calculated charging rate information and furthermore, adds up the daily rate and calculates a monthly rate and a rate per corresponding year and stores the calculated monthly rate and yearly rate in the database 60.

The output module 40 of the processor 120 may display the charging rate information calculated by the rate calculating module 30 on an AVN device 70 of the vehicle or a cluster 80 of the vehicle through CAN communication.

The output module 40 transmits the charging rate information stored in the database 60 to the server 10 and transmits the charging rate information to a mobile communication terminal 90 such as a smart phone of the user of the corresponding vehicle to allow the user to view the corresponding charging rate information anytime.

Next, a configuration of a charging rate forecasting method implemented by using the charging rate forecasting system for the electric vehicle according to an exemplary embodiment of the present disclosure configured as above will be described.

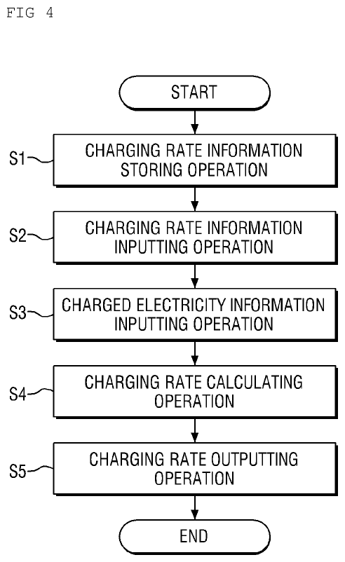

FIG. 4 is a flowchart of a charging rate forecasting method for an electric vehicle according to an exemplary embodiment of the present disclosure and hereinafter, the charging rate forecasting method according to an exemplary embodiment of the present disclosure will be described with reference to FIG. 4.

The charging rate forecasting method according to an exemplary embodiment of the present disclosure is performed by a system including: a server 10 receiving and storing information on a charging rate from an electric power supplier; an input module 20 receiving the information on the charging rate from the server 10 and receiving voltage information and current information charged in a vehicle from a charger 50 installed to charge the electric vehicle; a rate calculating module 30 calculating the charging rate of the vehicle according to the information on the charging rate input into the input module 20 and the voltage information and the current information input from the charger 50; and an output module 40 transferring the charging rate calculated by the charge calculating module 30 to an electronic control unit of the vehicle.

1) Charging Rate Information Storing Operation (S1)

The server 10 receives and stores charging rate information of electricity charged into the vehicle. The charging rate information is transferred from a management terminal 100 of a charge provider that supplies the electricity and transferred to the server 10 through a communication network.

As described above, the charging rate information is information on a charge provider that supplies electricity, charge information for each charge time, or charging rate information per month and when the charging rate information is charged or a new provider is added, the changed charging rate information is periodically transferred and updated to the server 10 from the management terminal 100. An example of the charging rate information is described through FIG. 2 described above.

2) Charging Rate Information Inputting Operation (S2)

The charging rate information stored in the server 10 is input into the input module 20.

3) Charged Electricity Information Inputting Operation (S3)

The voltage information and the current information (hereinafter, referred to as charged electricity information) charged in the vehicle is input from the charger 50 that supplies electric power to the vehicle.

In this case, the input module 20 receives voltage information and current information of electricity charged into the vehicle from an ECU of the vehicle through the charger 50 by using a CAN communication line of the vehicle.

4) Charging Rate Calculating Operation (S4)

The charging rate of the corresponding vehicle is calculated by using the received charging rate information and the charged electricity information.

As described above, the rate calculating module 30 stores a charged electric power amount per time period by accumulating the voltage information and the current information and calculates the charging rate per month according to the charging rate information of the charge provider input from the server 10 by using the stored charged electric power amount. In addition, the calculated charging rate is stored and managed in a linked database 60.

An example of the charging rate data calculated by the rate calculating module 30 is described with reference to FIG. 3 described above.

The charged electric power amount is calculated according to Equation to 1 to calculate the electric power and the charging rate is calculated according to Equation 2 above.

The rate calculating module 30 calculates a daily rate for the calculated charging rate information and furthermore, adds up the daily rate and calculates a monthly rate and a rate per corresponding year and stores the calculated monthly rate and yearly rate in the database 60.

5) Charging Rate Outputting Operation (S5)

The output module 40 displays the charging rate information calculated by the rate calculating module 30 on an AVN device 70 of the vehicle or a cluster 80 of the vehicle through CAN communication.

The output module 40 transmits the charging rate information stored in the database 60 to the server 10 and transmits the charging rate information to a mobile communication terminal 90 such as a smart phone of the user of the corresponding vehicle and the user views the received charging rate information by using the mobile communication terminal 90.

What is claimed is:

1. A charging rate forecasting system for an electric vehicle, comprising:
a server receiving and storing information on a charging rate from an electric power supplier; and
a processor configured to:
receive the information on the charging rate from the server and receive voltage information and current information charged in the vehicle from a charger installed to charge the vehicle;
calculate the charging rate of the vehicle according to the information on the charging rate and the voltage information and the current information input from the charger; and
transfer the calculated charging rate to an Electronic Control Unit (ECU) of the vehicle.

2. The charging rate forecasting system of claim 1, wherein the charging rate information is information on a charge provider that supplies electricity, charge information for each charge time, or charging rate information per month.

3. The charging rate forecasting system of claim 1, wherein the charging rate information is classified per charge provider, per charge time period, and per month.

4. The charging rate forecasting system of claim 1, wherein the processor receives voltage information and current information of electricity charged into the vehicle from the ECU of the vehicle through the charger by using a Controller Area Network (CAN) communication line of the vehicle.

5. The charging rate forecasting system of claim 1, wherein the processor is configured to store a charged electric power amount per time period by accumulating the voltage information and the current information and to calculate the charging rate per month according to the charging rate information of the charge provider input from the server by using the stored charged electric power amount.

6. The charging rate forecasting system of claim 1, wherein the processor receives current input into an On-Board Charger (OBC) at the time of slow charging when inputting the current information.

7. The charging rate forecasting system of claim 1, wherein the processor is configured to display the calculated charging rate information on an Audio-Video-Navigation (AVN) device of the vehicle or a cluster of the vehicle through a Controller Area Network (CAN) communication.

8. The charging rate forecasting system of claim 1, wherein the processor is configured to transmit the charging rate information stored in a database to the server, and the server is configured to transmit the charging rate information to a mobile communication terminal of a user.

9. A charging rate forecasting method performed by a system including a server receiving and storing information on a charging rate from an electric power supplier, and a processor configured to receive the information on the charging rate from the server and receive voltage information and current information charged in a vehicle from a charger of the vehicle, and to calculate the charging rate by using charging rate information, voltage information, and current information, the method comprising:
a charging rate information storing operation of receiving and storing, by the server, charging rate information of electricity charged into the vehicle from a management terminal of a charge provider;
a charging rate information inputting operation of inputting the charging rate information stored in the server into the processor;
a charged electricity information inputting operation of inputting the voltage information and the current information charged in the vehicle from the charger that supplies electric power to the vehicle into the processor;
a charging rate calculating operation of calculating the charging rate of the corresponding vehicle by using the charging rate information and the received charged electricity information; and
a charging rate outputting operation, performed by the processor, of displaying the calculated charging rate information on an Audio-Video-Navigation (AVN) device of the vehicle or a cluster of the vehicle.

10. The charging rate forecasting method of claim 9, wherein the processor is configured to transmit the calculated charging rate information to a mobile communication terminal of a user of the corresponding vehicle through the server.
